(19) United States
(12) Patent Application Publication
(10) Pub. No.: US 2003/0120492 A1
(43) Pub. Date: Jun. 26, 2003

(54) Apparatus and method for communication with reality in virtual environments

(76) Inventors: Ju Wan Kim, Taejon (KR); Chan Yong Park, Taejon (KR); Ki Jong Byun, Taejon (KR); Byung Tae Jang, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/082,333

(22) Filed: Feb. 26, 2002

(30) Foreign Application Priority Data
Dec. 24, 2001 (KR) 2001-84209

(51) Int. Cl. G10L 21/00; G10L 11/00

(52) U.S. Cl. 704/270

(57) ABSTRACT

A communication among participants in on-line virtual environments is disclosed. The communication with reality among the participants is effected in the diverse virtual environments such as an on-line game, chatting, etc., by converting a text message from a specified person into a speech having its own tone during the text message communication among the participants, and by reproducing the converted message through a receiver's speaker with a sound effect added thereto. The on-line communication by speech among the participants is effected without affecting the load of the network by converting the text message received in a user terminal into the speech using a text-to-speech converter, and by reproducing the converted speech through the speaker. By adopting a three dimensional (3D) stereophonic sound technique considering a positional relation between the message sender and receiver and the sound effect using the environment of the virtual space where the receiver currently exists, the communication can be effected by speech with reality and in a distinctive manner against the other participants.

### BACKGROUND OF THE INVENTION

1. Field of the Invention

The present invention relates to an apparatus and method for communication with reality in virtual environments, and more particularly, to an apparatus and method for communication with reality in virtual environments that enables communication with reality among participants without affecting the load of a network in the diverse virtual environments such as an on-line game, chatting, etc., by converting a text message from a specified person into a speech having its own tone during the text message communication among the participants and by reproducing the converted message through a receiver's speaker with a sound effect added thereto.

2. Background of the Related Art

Generally, for communication with one another, participants in a virtual space such as an on-line game in which a plurality of users participate type a string of characters using a keyboard. A virtual space server receives the string of characters inputted by the sender, and sends the corresponding character string to other participants who can currently see the sender. If a user receives another person's message from the server, the received text message is displayed on a specified position around the corresponding character or on a separate chatting window of the user's terminal. Thus, the user can recognize the received message, so that the communication among the participants can be effected.

However, if many users exist in the virtual space, their simultaneous saying of only a word may cause the whole display screen to be covered with characters, and this may rather disturb the communication among the participants. Further, though all the participants use the same communication method called the text-based chatting, it is preferable that the communication is effected in a distinct manner according to the user's acquaintance with the participants.

Conventionally, Korean Patent Laid-open No. 1998-038400 “Apparatus for supporting an audio chatting in virtual environments” discloses the message transfer through an audio compression in a server-client structure.

The above apparatus has problems in that it should transmit audio data of the respective user to all other users' apparatuses, and this causes the corresponding throughput of audio data to greatly increase with the occurrence of the bottleneck phenomenon of the system.

Also, Korean Patent Application No. 10-1999-0010989 “Game-dedicated audio chatting method and apparatus” discloses an audio chatting method that enables communications with the same parties during an Internet game. According to this method and apparatus, messages from respective clients are transferred to a server, and the server selectively transmits the messages only to the same parties. This method and apparatus enable a smooth communication among the participants with the load of the network reduced, but the throughput of audio data greatly increases with the occurrence of the bottleneck phenomenon of the network.

Also, Korean Patent Laid-open No. 2000-072831 “Call system using Internet” discloses the connection through a server. However, this call system does not consider the efficiency of an audio transmission and the bandwidth for a phone call through the central server.

As described above, the conventional audio-based communication methods through the network has the disadvantages in that they require a wide bandwidth of the network, and the user's voice is exposed to the virtual environment as it is.

### SUMMARY OF THE INVENTION

Accordingly, the present invention is directed to an apparatus and method for communication with reality in virtual environments that substantially obviates one or more problems due to limitations and disadvantages of the related art.

It is an object of the present invention to provide an apparatus and method for communication with reality in virtual environments that enables on-line communication by speech among participants without affecting the load of a network in diverse virtual environments by converting a text message received from a specified person to a user's terminal into a speech using a text-to-speech converter and by reproducing the converted message through a speaker. The present invention adopts a three dimensional (3D) stereophonic sound technique considering a positional relation between the message sender and receiver, and a sound effect using the environment of the virtual space where the receiver currently exists, so that the communication can be effected by speech with reality and in a distinctive manner against the participants.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a communication method among participants connected through a network in virtual environments, comprising the steps of a plurality of senders inputting and transmitting text messages, a receiver selecting reception and conversion of the text message from a desired sender among the plurality of senders into a speech, and the receiver converting the text message of the desired sender into the speech and outputting the speech through a speaker while transmitting/receiving the text messages to/from other participants.

Preferably, the step of selecting reception and conversion of the text message from the desired sender comprises the steps of selecting an identifier of the sender, determining a virtual voice of the sender, and determining a sound effect such as music and so on by grasping a virtual position of the sender.

In another aspect of the present invention, there is provided a communication apparatus among participants in virtual environments, comprising a text message receiving means for receiving a text message from a determined user, a phoneme dividing means for dividing the text message received through the text message receiving means into phonemes, a text-to-speech conversion means for converting by characters the phonemes divided by the phoneme dividing means into a speech, and a sound effect providing means for providing music or sound effect to the speech.

Preferably, the text-to-speech conversion means includes a speech synthesis means for synthesizing the speech by vocabulary, and the sound effect providing means includes a tone generating means for providing a tone, an accent, and an intonation of the speech.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating the construction of an apparatus capable of transmitting/receiving by speech a text message of a specified person determined by a user according to the present invention.

FIG. 2 is a flowchart illustrating a process of receiving a text message from a transmitting end and converting the text message into an audio message according to the present invention.

FIG. 3 is a schematic view of a communication apparatus for converting a text message onto a speech according to the present invention.

### DETAILED DESCRIPTION OF THE PREFERRED EMBODIMENT

The apparatus and method for communication with reality in virtual environments according to the preferred embodiment of the present invention will now be explained in detail with reference to the accompanying drawings.

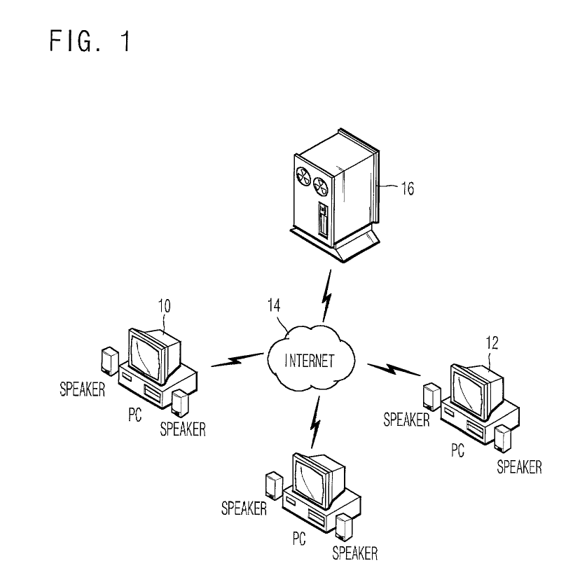

FIG. 1 is a view illustrating the system construction of an apparatus capable of transmitting/receiving by speech a text message of a specified person determined by a user during the user's transmission/reception of the text message to/from a plurality of users such as an on-line game, chatting, etc., according to the present invention.

The system includes terminals 10 and 12 having a speaker, an Internet 14 for connecting to a virtual environment, and a server 16 for providing an Internet service in the virtual environment.

The user performs the game or chatting in the virtual environment through the Internet 14 using his/her own terminal 10. The chatting or game program is provided from the server 16.

Meanwhile, if the user selects an audio conversion of the text message from an opposite party desired by the user during transmission/reception of the text message in the game or chatting using the terminal 10, the text message sent from the opposite party can be converted into a speech.

At this time, the user's terminal 10 is provided with a communication apparatus that can convert the text into the speech, determine the tone of the opposite party, and provide a sound effect according to the position of the opposite party.

The transmission part transmits a message in the form of a text to participants related to the message of the transmission part through a virtual space server by inputting the text message using a keyboard. The terminal 12 of the receiving part receives the message, and determines whether to output the text message by speech or in a conventional manner according to the sender's ID. If it is determined to output the message by speech, the terminal outputs the speech with the sender's own voice, considering the 3D positional relation between the sender and the receiver and the environment.

At this time, the respective user in the virtual environment can determine the ID of the opposite party whose message will be reproduced by speech. The IDs of the respective users are stored in advance in a database of the server or the terminals 10 and 12. Also, the respective user has his/her own tone code used during the reproduction of the speech in order for the opposite party can recognize the user only by the tone of the reproduced message. For example, the tone code may correspond to a man's voice having a deep tone, a woman's voice of soprano, etc.

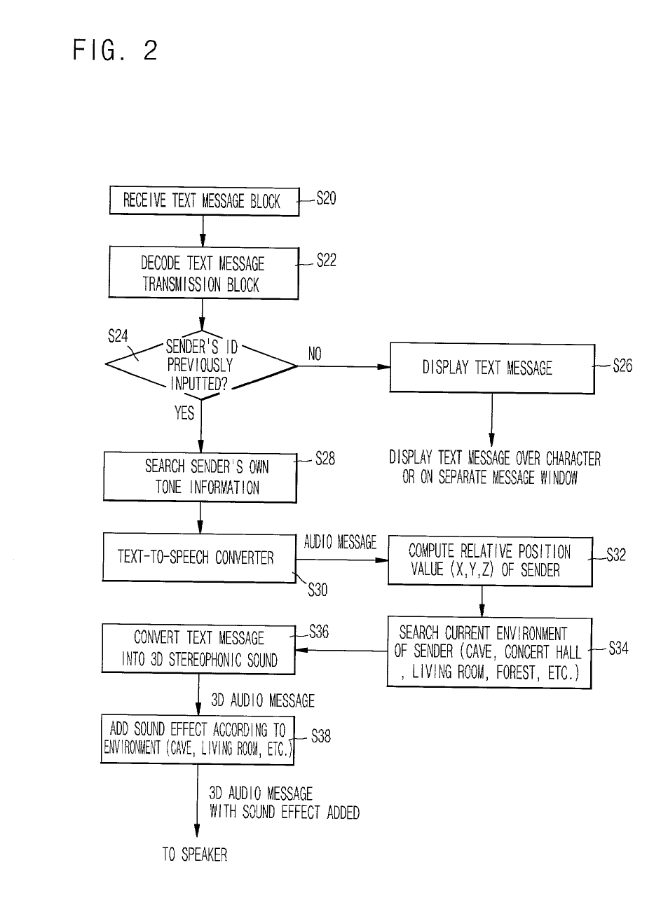

FIG. 2 is a flowchart illustrating a process of receiving a text message from a transmitting end and converting the text message into an audio message.

A text message block that is sent from the opposite party to the user during the performing of the game or chatting in the virtual environment is composed of a sender's own ID and a character string of the message (step S20 and S22).

The receiver's terminal 10 separates the sender's ID from the received message, and searches an output method of the received message from an ID list that defines whether the message received from the respective sender is to be reproduced by text or speech with a predetermined (step S24).

In case of the ID whose message is to be outputted by text, the terminal outputs the text message over the corresponding character displayed on the screen or on a separate message window in the same manner as the conventional chatting method (step S26).

In case of the ID whose message is to be stored and outputted by speech, the terminal searches the sender's own tone using the sender's ID. The respective tone is determined corresponding to a male voice, female voice, deep voice, sound of machine, etc. Meanwhile, the determination of the ID whose message is to be converted into the speech can also be performed during transmission/reception of the text message (step S28).

The terminal converts the sender's text message into the speech through a text-to-speech engine using the sender's own tone code, and then stores the speech in a buffer (step S30).

Then, the terminal searches the sender's 3D position (X,Y,Z) in the virtual space, and computes the relative 3D position (X,Y,Z) from its own position. That is, in case of playing the game, it computes the sender's position and the receiver's position (steps S36 and S38).

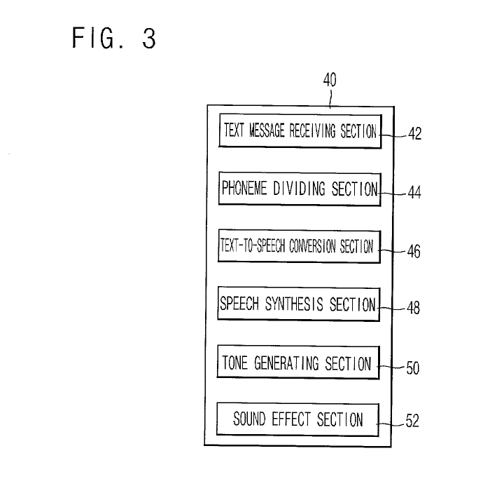

FIG. 3 is a schematic view of a communication apparatus 40 according to the present invention.

The communication apparatus 40 includes a text message receiving section 52, a phoneme dividing section 44, a text-to-speech conversion section 46, a speech synthesis section 48, a tone generating section 50, and a sound effect section 52.

The text message receiving section 52 receives the text message from a determined sender, and the phoneme dividing section 44 divides the text message received through the text message receiving section 52 into phonemes to convert the text message into the speech.

The text-to-speech conversion section 46 converts the text message divided into the phonemes into the speech, and the speech synthesis section 48 synthesizes the converted speech by vocabulary to take effect as if the sender actually speaks.

Also, the tone generating section 50 selects and provides the tone, accent, intonation, etc., of the speech, and the sound effect section 52 provides a proper music or sound effect as if the user is positioned in a cave, forest, etc., during the game or chatting.

Consequently, the text message is selectively reproduced by speech through the text-to-speech converting engine in such a manner that the character string is divided into phonemes, a sound wave signal is generated according to the divided phonemes, and the generated sound wave signal is amplified and outputted to the speaker.

As described above, the apparatus and method for communication with reality in virtual environments according to the present invention can solve the problems in that if many users simultaneously communicate with one another using text messages in the virtual space, too many characters for communication are displayed on the whole display screen, and this disturbs the communication among the participants, and enable the on-line communication by speech with respect to the message from a specified user while maintaining transmission/reception of the text messages to/from other users.

Accordingly, in accordance with the user's selection, the communication among the participants in the virtual environments can be effected in a distinctive manner, i.e., by text or speech, and with priority against the participants.

Also, according to the present invention, by giving diverse speech synthesizing variables for audio reproduction, every user has his/her own voice, and this enables the communication in the virtual environment to be performed easily and with reality.

Also, by adopting a 3D stereophonic sound technique considering a positional relation between the user and the other party and a sound effect that matches the environment such as a cave, living room, etc., the communication in the virtual environment can be effected by speech with reality.

Since the communication on network is effected through transmission of the text messages, the present invention enables the on-line communication by speech without affecting the load of the network.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A communication method among participants connected through a network in virtual environments, the method comprising the steps of:
a plurality of senders inputting and transmitting text messages;
a receiver selecting reception and conversion of the text message from a desired sender among the plurality of senders into a speech; and
the receiver converting the text message of the desired sender into the speech, and outputting the speech through a speaker while transmitting/receiving the text messages to/from other participants.

2. The method as claimed in claim 1, wherein the step of selecting reception and conversion of the text message from the desired sender comprises the steps of:
selecting an identifier of the sender;
determining a virtual voice of the sender; and
determining a sound effect such as music and so on by grasping a virtual position of the sender.

3. The method as claimed in claim 2, wherein the step of determining the virtual voice of the sender determines the voice to be outputted through the speaker, an accent of the voice, and an intonation of the voice.

4. A communication apparatus among participants in virtual environments, comprising:
a text message receiving means for receiving text messages from a plurality of senders;
a phoneme dividing means for dividing the text message received through the text message receiving means into phonemes;
a text-to-speech conversion means for converting by characters the phonemes divided by the phoneme dividing means into a speech; and
a sound effect providing means for providing a music or sound effect to the speech.

5. The apparatus as claimed in claim 4, wherein the text-to-speech conversion means includes a speech synthesis means for synthesizing by vocabulary the converted speech.

6. The apparatus as claimed in claim 4, wherein the sound effect providing means includes a tone generating means for providing a tone, an accent, and an intonation of the speech.
